(19) United States
(12) Patent Application Publication
(10) Pub. No.: US 2005/0232405 A1
(43) Pub. Date: Oct. 20, 2005

(54) Method and apparatus for determining a user presence state

(75) Inventor: Garold B. Gaskill, Camas, WA (US)

Correspondence Address: ROBERT D. VARITZ, 4915 S.E. 33RD PLACE, PORTLAND, OR, 97202, US

(73) Assignee: Sharp Laboratories of America, Inc.

(21) Appl. No.: 11/022,366

(22) Filed: Dec. 24, 2004

Related U.S. Application Data
(63) Continuation-in-part of application No. 10/825,734, filed on Apr. 15, 2004.

(51) Int. Cl. H04M 3/42; H04M 1/00; H04M 9/00

(52) U.S. Cl. 379/201.06; 379/430

(57) ABSTRACT

A method of determining a user presence state includes in a telephonic device, for use by a user to receive and transmit an acoustic wave, detecting orientation of the telephonic device to signal a user presence state. An apparatus for determining and reporting a user presence state includes a gravity sensing mechanism for detecting the user's presence via the orientation of the telephonic device relative to gravity, wherein the gravity sensing mechanism generates user presence information to be sent taken from the group of user presence states consisting of “Gone” when the headset is disconnected from a base station; “Away” when the headset is connected and the orientation of the microphone is level with the earpiece; “Busy” when the headset is connected and the orientation of the microphone is above that of the earpiece; and “Available” or “Busy in Current Conversation” when the headset is connected and the orientation of the microphone is below that of the earpiece.

### RELATED APPLICATION

This application is a continuation-in-part of U.S. patent application Ser. No. 10/825,734, filed Apr. 15, 2004, for Method of Determining a User Presence State.

### FIELD OF THE INVENTION

This invention relates to telephonic headsets, and specifically to a method of signalling the presence and state of a user by headset orientation.

### BACKGROUND OF THE INVENTION

Analog phone systems indicate “presence” of the called party in several indirect ways. These include a ring but no answer or a busy signal. This information is delivered only when a caller initiates a call to a called party. A ring with no answer or an answer by a telephone answering device does not indicate whether or not the person desired is present and available for communication, nor does it indicate how long it may be before a response is given. An announcement (outgoing message) may be left on the answering machine, but it is rarely convenient to do so.

Even with the advent of EMail, and Instant Messaging (IM), i.e., so called “text chat,” there is still a need to know the status of the person (buddy) receiving the messages. Presence in EMail and text chat is handled by the user entering a status message into a computer, such as “I'm in but busy,” or “I'm on vacation,” etc. The message is made available to all in a “buddy” list. If a user's status message is not entered, or not changed as the user's actual status changes, the caller, or person sending a message, does not know whether the called party is really available to respond quickly or not. Also, with always-on broadband access, the fact that a person is logged into a “text chat” application does not necessarily indicate that the person is truly present and available for communication. There are existing methods that utilize the duration of time where there has been no user interaction with the computer to automatically indicate presence, but these methods are not effective when using a headset. Without the actual knowledge of user's status, the caller may be frustrated, or feel the need to attempt other methods to contact the desired party. In addition, digital phone technologies permit multiple conversations to be handled concurrently, but provide no known methods to indicate presence, or to make handling these new capabilities easy. Hence, it is desirable to know that a person is available (present) to accept a call. That capability is not available with analog communication systems without direct user interaction.

U.S. Pat. No. 6,700,966 B2 for System, apparatus and method for processing calls based on place detection of moving personnel or objects, to Takagi et al., granted Mar. 2, 2004, describes use of a physical location (room) of a person's badge as the method to indicate “presence” and hence determine if a telephone call should be placed, by using the location of the mobile device.

U.S. Pat. No. 6,700,967 B2 for Presence information method and system, to Kleinoder et al., granted Mar. 2, 2004, describes determination of “presence” information from legacy phone devices using call status currently in progress (busy) and the time since the end of a call (highly available decreasing to unknown availability with time).

U.S. Pat. No. 6,584,182 B2 for Method and apparatus for communicating data over a telephone line using an acoustic modem, to Brodnick, granted Jun. 24, 2003, permits orientation independent insertion of a handset into a modem cradle.

U.S. Pat. No. 6,377,684 B1 for Telephone headset, to Lucey et al., granted Apr. 23, 2002, describes a headset having a rotating microphone.

U.S. Pat. No. 5,712,911 for Method and system for automatically activating and deactivating a speaker phone, to Her, granted Jan. 27, 1998, describes a method for activating a speaker phone in response to an incoming call based on the presence or absence of a subscriber within a predetermined proximity zone. This method uses the location of the user relative to the phone rather than the orientation or position of handset, headset or ear bud speaker and microphone. The event controlled is the speaker in response to a call.

U.S. Pat. No. 5,596,633 for Charger/detector for cordless telephone, to Meier et al., granted Jan. 21, 1997, describes a method for detecting presence of a user near the phone/line. These include presence of the cordless handset in the charger, an RF badge on the person, an RF or IR transmitter on the handset. The methods described to detect presence do not include orientation or position of handset, headset or ear bud speaker and microphone.

U.S. Pat. No. 5,488,657 for Apparatus for and method of operating an automatic log on/log off circuit in a telephone system by disconnecting a headset, to Lynn et al., granted Jan. 30, 1996, describes a method of detecting presence based on disconnection of the head set from the amplifier. The methods described to detect presence do not include orientation or position of handset, headset or ear bud speaker and microphone.

U.S. Pat. No. 5,068,645 for Computer input device using an orientation sensor, to Drumm, granted Nov. 26, 1991, describes a method of detection orientation of the user's head by means of sensors in a headset and uses the information to control the cursor of a computer. It is not designed to detect presence nor is the orientation of portions of the headset relative to other portions of the headset described.

U.S. Pat. No. 4,932,050 for Proximity detector for telecommunications features, to Davidson et al., granted Jun. 5, 1990, describes a method of providing presence via proximity of the person to the telephone.

U.S. Pat. No. 4,504,701 for Telephone having circuitry for reducing the audio output of the ringing signal, to Lucchesi, granted Mar. 12, 1985, describes a telephone which changes ringing volume based on handset orientation via a gravity switch, but does not provide information about the status of the user.

U.S. Patent Publication No. 2002/0193080 for Movemet [sic] and attitude controlled mobile station control, of Komsi et al., published Dec. 19, 2002, describes use of reflective detectors on one device to determine the location of a mobile device. The application proposes proprioceptive sensors, i.e., self determining detection of motion or orientation, to send an outgoing message in response to a call based on the orientation state of the mobile unit. The method of the invention includes detecting at least one acceleration during a time interval, detecting an incoming call and selecting an announcement based on the at least one acceleration.

GB2390264A, for Detecting position of use in a mobile telephone, of Layley et al., published Dec. 32, 2003, describes a method of determining if a user is driving, holding and using a mobile phone. The results of the methods to determine orientation are presumably used to stop the call and enforce safer driving practices. No mention is made that information regarding handset orientation is used to provide presence or availability for conversation.

WO02091714 A2 for Mobile radio device, of Suzuki et al., published Nov. 14, 2002, describes orientation of a device with a display to reduce the power consumption to the display when it is not viewable by the user.

EP1104143 A2 for Handheld devices, of Kaartinen et al., published May 30, 2001, describes a method for securing exclusive use of a mobile phone and used the orientation or gestures provided by the user to identify the user. The method requires a training process so that processor can identify the orientation based input from acceleration sensors.

EP 0365741 A2, for Security Handset, of McClain, granted Dec. 14, 1994, describes a handset which prevents transmission of voice while “on hook,” based on handset orientation.

### SUMMARY OF THE INVENTION

A method of determining a user presence state includes in a telephonic device, for use by a user to receive and transmit an acoustic wave, detecting orientation of the telephonic device to signal a user presence state. An apparatus for determining and reporting a user presence state includes a gravity sensing mechanism for detecting the user's presence via the orientation of the telephonic device relative to gravity, wherein the gravity sensing mechanism generates user presence information to be sent taken from the group of user presence state signals consisting of “Gone” when the headset is disconnected; “Away” when the headset is connected and the orientation of the microphone is level with the earpiece; “Busy” when the headset is connected and the orientation of the microphone is above that of the earpiece; and “Available” or “Busy in Current Conversation” when the headset is connected and the orientation of the microphone is below that of the earpiece.

It is an object of the invention to provide an intuitive and/or automatic method for detecting the presence and availability of a user for conversation via the use of a telephone headset.

Another object of the invention is to provide an automatic apparatus for notifying a caller as to the presence and availability of a user for conversation via the use of a telephone headset.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 depicts a headset of the invention and the various orientations of that headset which may be incorporated into the method of the invention.

FIG. 2 is a schematic representation of the headset of the invention.

FIG. 3 depicts the switch mechanism of the invention in an “Away” position.

FIG. 4 depicts the switch mechanism of the invention in a “Busy” position.

FIG. 5 depicts the switch mechanism of the invention in a “Ready” position.

FIG. 6 microphone orientation vs. switch contact condition.

### DETAILED DESCRIPTION OF THE PREFERRED EMBODIMENTS

This invention provides an intuitive and/or automatic method for detecting the presence and availability of a user for conversation via the use of the telephone handset or headset. The invention provides a protocol and apparatus for using a telephone headset to automatically signal user presence information, or user presence state. As used herein, “telephonic device” is a device, such as a headset, which is used to receive and transmit an acoustic wave, e.g., which allows the user to hear a speaker through a speaker and to talk to another party through a microphone. For a headset, this includes orientation of the microphone relative to the earpiece speaker, whether the headset is in place on a user's head, and whether the headset is connected to a telephonic device. These orientations and connection indicia enable the user to easily and intuitively communicate his presence to his communication equipment, and thus to any calling party.

A user's presence, and degree of readiness to participate in a voice conversation, may be specified by the exemplar four user presence states defined in Table 1. More, fewer or other presence states may be defined, as required, within the scope of the method of the invention. For example, some presence states used by current PC based phones include: “on vacation,” “out to lunch,” “just stepped out,” “not available,” “do not disturb,” “off line,” “away,” etc. If the user has text entry capability, these more specific messages may be added as information which is sent when the basic presence state information indicates the user is “Gone”. However, for purposes of this description, the following four presence states will be used.

TABLE 1

| User Presence | |
|---|---|
| State | Explanation |
| Gone | The user is neither present nor available |
| | for voice chat for an extended time. |
| Away | The user is neither present nor available |
| | for voice chat for a short time. |
| Busy | The user is present but currently busy doing |
| | something else and not currently able to chat. |
| Available or Busy | The user is present and available, |
| in Current | listening to or talking on a current conversation |
| Conversation | |

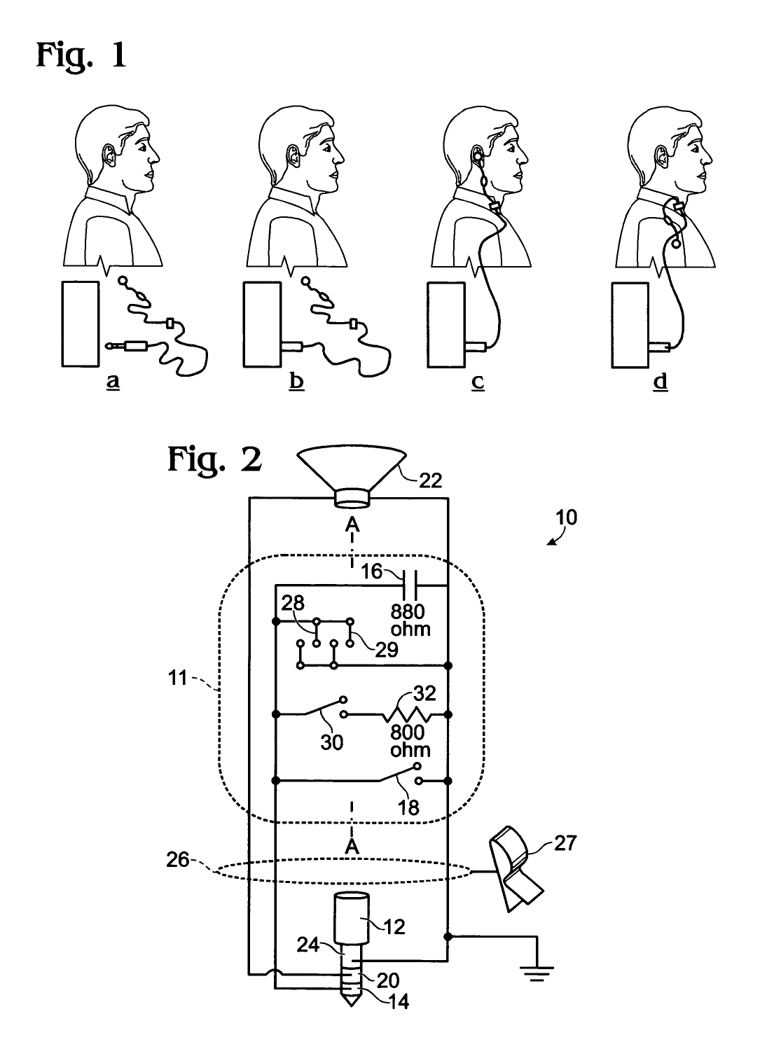

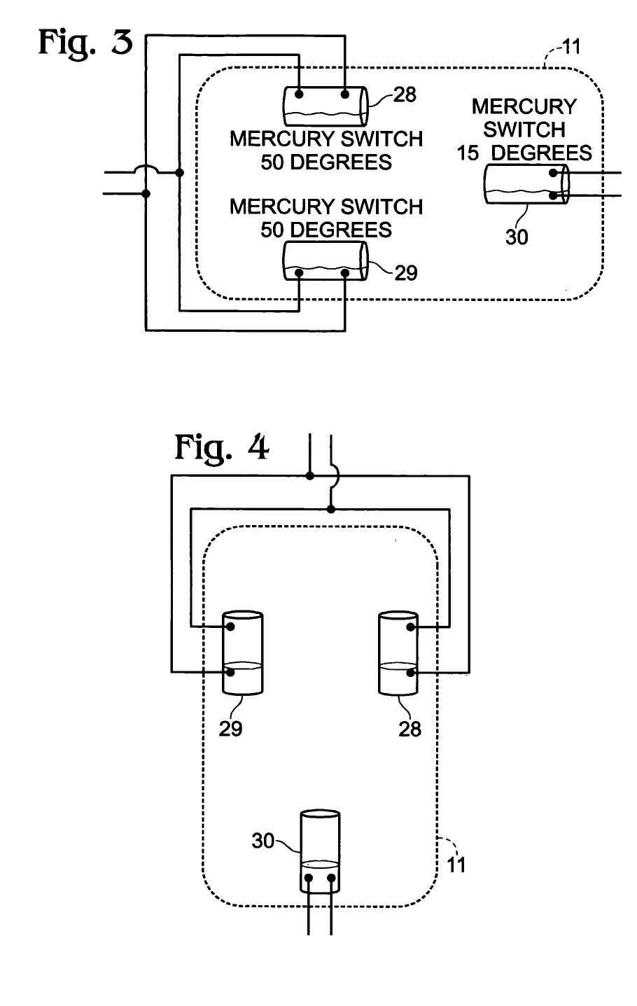

These states are determined for an ear bud and dangling microphone headset as follows: If the jack connecting the headset to the phone base is not inserted, FIG. 1a, this indicates the user is “Gone.” If the jack connecting the headset to the phone base is inserted, there is power to the headset and the orientation of microphone is horizontal, this indicates the user is “Away,” FIG. 1b and FIG. 3. If the jack connecting the headset to the phone base is inserted, there is power to the headset and the orientation of microphone is upside down (inverted, or above the ear bud speaker), this indicates the user is “Busy,” FIG. 1c and FIG. 4. If the jack connecting the headset to the phone base is inserted, there is power to the headset and the orientation of microphone is upright (right-side up or below the ear bud speaker) this indicates the user is “Available” or “Busy in a current conversation,” FIG. 1d. The system can easily determine whether there is an active session or call to distinguish between “Available” and “Busy in a current conversation.”

The device for the user's communication equipment to determine the position of the microphone, or any other portion of the headset, may include a gravity switch, or other methods known in the art. Referring now to FIG. 2, a schematic of the headset of the invention is depicted generally at 10. Headset 10 includes a microphone capsule 11, which includes a microphone and related circuitry, and a connector in the form, in the preferred embodiment, of a 2.5 mm stereo plug 12. A switch (not shown) is located in the headset base which is closed when the plug is inserted into a headset jack in the base. Plug 12 includes a plug tip 14, which transmits a signal from a microphone 16, typically, an electret capsule microphone having a mean signal of 2.4 V DC, when in use during a call on a standard headset, or when plugged into a cell phone. A 100 mV AM audio signal is impressed on the 2.4 V DC when speaking. The microphone typically has high impedance, e.g., 880 ohm. A button 18 in microphone capsule 11 shorts the supplied microphone bias voltage to ground. This negative pulse to ground, if being called, answers the call; if on a call, hangs up, and if not on call or not getting a call, redials last number. Plug ring 20 receives a signal for a headphone speaker 22, typically around 32 ohms. Plug shield 24 supplies ground for microphone 16 and speaker 22. The wires for the microphone capsule and the speaker are bundled into cable bundle 26 between plug 12 and the remainder of the headset. A clip 27 allows a user to secure headset 10 to the user's clothing.

Headset 10 and its associated base detect user presence information by measuring the impedance between the microphone and ground. A gravity sensing mechanism, including, in the preferred embodiment, gravity switches, in the preferred embodiment, located in microphone 16 to provide changes to the impedance. In the preferred embodiment, microphone 16 includes a housing having a longitudinal axis, “A”, and having a cross-section perpendicular to axis A which causes microphone 16 to lay in a desired orientation when placed on a substantially horizontal surface. The microphone housing may be elliptical, oval, etc, so long as it has a major transverse axis and a minor transverse axis, and lays with its major transverse axis substantially parallel to the surface on which it rests. Two gravity switches 28, 29, are provided, in the preferred embodiment, in microphone capsule 11 and are oriented such that an electrical circuit is closed whenever the microphone and cord are placed on a horizontal surface, as shown in FIG. 6. In the preferred embodiment, whenever the microphone and cord are placed on a horizontal surface, and the major transverse axis of the microphone housing lays substantially parallel to the horizontal surface, i.e., within 50° of horizontal, either switch 28 or 29 will close, A third gravity switch 30 is oriented such that an electrical circuit is closed when microphone capsule 11 is in the “Busy” position, and the microphone longitudinal axis is within 15° of vertical, and the earpiece is oriented below the microphone. Gravity switches 28, 29 and 30 may be mercury based, roller ball, magnetic roller ball with Hall Effect, or any other gravity sensing configuration.

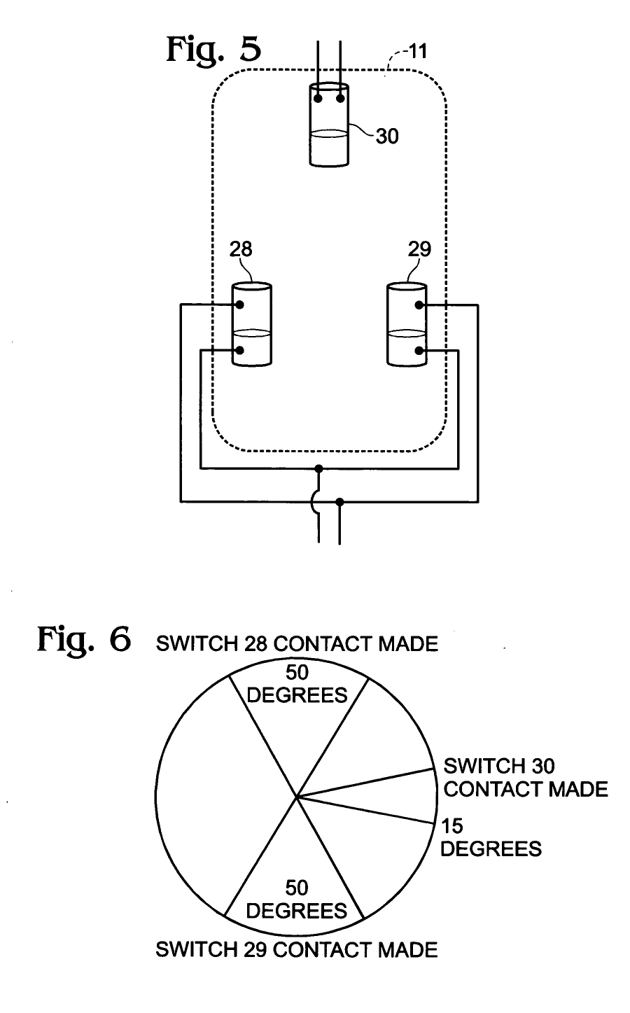

If the ear bud/in line microphone is disconnected from the headset base, the headset base detects the absence of speaker and microphone loads. Thus, if the measured microphone impedance is, e.g., >1 Ok Ω, the person is “Gone for the day,” which user presence information is provided to a caller. If the headset is connected to the ear bud/in line microphone and the microphone is in a horizontal orientation, ±25°, as shown in FIG. 3, gravity switch 28 or 29 is closed, gravity switch 30 is open, resulting in an impedance near zero, indicating that the user is “away from the station,” which user presence information is provided to a buddy, or potential caller, which is the switch condition depicted in FIG. 6. If the headset is connected to the ear bud/in line microphone, and the microphone is upside down, i.e., the ear bud is below the level of the microphone, FIG. 4, only gravity switch 30 is closed, resulting in an impedance of about half the normal microphone impedance by adding an 800 ohm resistor 32 in parallel with the microphone and ground. Thus if the impedance is about half the normal 800 ohms, the user is “Busy,” as indicated in FIG. 1c, wherein the headset is draped about the user's neck, or, which also occurs if the earpiece is removed from the user's ear, and suspended from clip 27. If the handset is connected to the ear bud/in line microphone and the microphone is right side up, FIG. 5, all of the gravity switches are open, providing the normal impedance between the microphone and ground, indicating that the user is available, or busy on a current call or session.

Other states may be generated and identified as required. For example, if the headset had a rechargeable battery or a super capacitor and wireless communication capability, a state, wherein a user temporarily unplugs the jack from the phone base to perform a brief task away from the desk, but still has the ear bud inserted, or the microphone vertical, may be supplied wirelessly as “Busy” or “Away.”

If the user is “Gone,” “Away” or “Busy,” the voice information of the current caller, and any other callers, is recorded by conventional means, such as digital telephone answering device, for future play back. If multiple conversations are ongoing, then currently unselected callers are also directed to the recorder. The user presence states, as a function of the orientation of the headset, along with examples of action taken by a user's communication equipment in response to the presence states, are summarized in the table below:

TABLE 2

| | | | Impedence |
|---|---|---|---|
| | | Example of | Measured by |
| | Exemplary Methods for | action to take in | Base between |
| | Headset having ear bud | response to | Microphone |
| User Presence State | with dangling microphone | Presence State | and Ground |
| Gone | Headset jack not inserted into | Record all user's | Base sees |
| | phone headset or base | voice chat as | “open” |
| | | unheard and | |
| | | indicate “Gone” to | |
| | | all callers or | |
| | | potential callers | |
| Away | Headset jack inserted with | Record all user's | Base sees short |
| | microphone in horizontal | voice chat as | |
| | position | unheard and | |
| | | indicate “Away” to | |
| | | all callers or | |
| | | potential callers | |
| Busy | Microphone upside-down | Record all user's | Base measures |
| | | voice chat as | ˜400 Ω |
| | | unheard and | |
| | | indicate “Busy” to | |
| | | all callers or | |
| | | potential callers. | |
| Available | Headset jack inserted with | Indicate | Base measures |
| | microphone upright and no | “Available” to | ˜800 Ω |
| | current session in progress | potential callers. | |
| | | Display notice of | |
| | | previously | |
| | | recorded but | |
| | | unheard calls and | |
| | | chat. Begin a | |
| | | current session if a | |
| | | call or voice chat | |
| | | comes in. | |
| Busy in Current | Headset jack inserted with | Record current | Base measure |
| Conversation | microphone upright (current | user's voice chat | ˜800 Ω and has |
| | session) | as heard and other | a current |
| | | user's voice chat | session |
| | | as unheard. | |
| | | Indicate “Active” | |
| | | to current call and | |
| | | “Busy” to | |
| | | potential callers. | |

Having determined the methods of signaling a user presence status, the information obtained may be presented to the caller, or buddy, in a number of ways. For example, lights or text on the caller's equipment may indicate presence state of the user, brief audio signals, e.g., audio icons, may be used to indicate a transition to a new state. For example, as in current “chat rooms” the sound of a door closing could be an indication of a transition to “Gone,” while the sound of an electric motor running for a few seconds could indicate the user has transitioned to “Busy”. The details of these presentation methods are a matter of choice in the implementation of the method of the invention. The methods to transmit the user's presence status to a calling or potential calling party (buddy) are well known to those of ordinary skill of the art of voice-over-internet, session internet protocol (SIP), SIP for instant messaging and presence leveraging extensions (SIMPLE), both of which are Internet Engineering Task Force (IETF) protocols.

A valuable commercial use for the invention is in call centers, where customer service representatives (CSR's) may call upon technical experts (TE's) to solve a customer's problem. Assuming it is a large call center, the CSR needs to know which of several TE's, who are able to address the problem, are indeed available. Knowing which TE is available avoids a common problem wherein the caller is forwarded to a person who is busy or gone and thus can not handle the forwarded call. With this invention, the CSR may obtain the presence information provided by the ear bud headset and successfully forward the call to an available technical expert.

Thus, a method of determining a user presence state has been disclosed. It will be appreciated that further variations and modifications thereof may be made within the scope of the invention as defined in the appended claims.

1. A method of determining a user presence state, comprising:
in a telephonic device, for use by a user to receive and transmit an acoustic wave, detecting orientation of the telephonic device to signal a user presence state.

2. The method of claim 1 wherein the telephonic device is a headset and the relative orientation of a headset microphone to a headset earpiece determines a user presence state.

3. The method of claim 2 wherein the user presence state to be sent is taken from the group of user presence states consisting of “Gone” when the headset is disconnected; “Away” when the headset is connected and the orientation of the microphone is level with the earpiece; “Busy” when the headset is connected and the orientation of the microphone is above that of the earpiece; and “Available” or “Busy in Current Conversation” when the headset is connected and the orientation of the microphone is below that of the earpiece.

4. The method of claim 1 wherein the telephonic device is a headset and the orientation of a headset microphone to vertical determines a user presence state.

5. The method of claim 1 wherein the user presence state is reported to a base station.

6. The method of claim 5 wherein the user presence state is taken from the group of user presence states consisting of “Gone” when the headset is disconnected from the base station; “Away” when the microphone is substantially horizontal; “Busy” when the headset is connected to the base station and the orientation of the microphone is inverted; and “Available” or “Busy in Current Conversation” when the headset is connected to the base station and the orientation of the microphone is right-side up.

7. An apparatus for determining and reporting a user presence state, comprising:
in a telephonic device, for use by a user to receive and transmit acoustic information, a gravity sensing mechanism for detecting the user's presence via the orientation of the telephonic device relative to gravity.

8. The apparatus of claim 7 wherein the telephonic device is connected to a base station.

9. The apparatus of claim 7 where the presence information is sent to all people on a buddy list.

10. The apparatus of claim 7 where the presence information is sent a caller.

11. The apparatus of claim 7 wherein the telephonic device is a headset and the relative orientation of a headset microphone to a headset earpiece determines a user presence state.

12. The apparatus of claim 11 wherein the gravity sensing mechanism generates user presence information taken from the group of user presence state signals comprising “Gone” when the headset is disconnected from a base station; “Away” when the headset is connected to a base station and the orientation of the microphone is level with the earpiece; “Busy” when the headset is connected to a base station and the orientation of the microphone is above that of the earpiece; and “Available” or “Busy in Current Conversation” when the headset is connected to a base station and the orientation of the microphone is below that of the earpiece.

13. The apparatus of claim 7 wherein the telephonic device is a headset and the orientation of a headset microphone to vertical determines a user presence state.

14. The apparatus of claim 13 wherein the user presence state signal to be sent is taken from the group of user presence state signals consisting of “Gone” when the headset is disconnected from a base station; “Away” when the headset is connected to a base station and the microphone is substantially horizontal; “Busy” when the headset is connected to a base station and the orientation of the microphone is inverted; and “Available” or “Busy in Current Conversation” when the headset is connected to a base station and the orientation of the microphone is right-side up.

15. The apparatus of claim 7 wherein the telephonic device includes a microphone housing having a longitudinal axis, a major transverse axis perpendicular to the longitudinal axis and a minor transverse axis perpendicular to the longitudinal axis, and wherein, when the microphone housing is places on a substantially horizontal surface, the major transverse axis will lay substantially parallel to the horizontal surface.
